(19) United States
(12) Patent Application Publication
(10) Pub. No.: US 2018/0032999 A1
(43) Pub. Date: Feb. 1, 2018

(54) SYSTEM AND METHOD FOR MAKING PAYMENT WITHIN A DIGITAL MESSAGING ENVIRONMENT

(71) Applicant: MASTERCARD ASIA/PACIFIC PTE LTD, Singapore (SG)

(72) Inventors: Krishnadas MOHANDAS, Singapore (SG); Benjamin Charles GILBEY, Singapore (SG); Vijin VENUGOPALAN, Singapore (SG)

(73) Assignee: MASTERCARD ASIA/PACIFIC PTE LTD, Singapore (SG)

(21) Appl. No.: 15/650,149

(22) Filed: Jul. 14, 2017

(30) Foreign Application Priority Data
Jul. 27, 2016 (SG) 10201606192Y

(51) Int. Cl. G06Q 20/32; G06Q 20/12; G06Q 20/14; G06Q 20/16

(52) U.S. Cl. CPC G06Q 20/3255; G06Q 20/16; G06Q 20/12; G06Q 20/14

(57) ABSTRACT

There is provided a system and method for making payment within a digital messaging environment. The payment can be made without exiting from the digital messaging environment, and can be activated by typing pre-defined text in the digital messaging environment.

### TECHNICAL FIELD

Embodiments of the present invention relate to a system, and method for making payment within a digital messaging environment.

### BACKGROUND

In today's environment where messaging applications and messaging portals are prevalent, many users typically use the messaging applications and messaging portals to carry out conversations and exchange media.

Currently, the messaging applications and portals have evolved to include aspects of artificial intelligence (AI). The AI incorporated into the messaging applications and portals typically provide customer/butler/concierge service for the users. However, the customer/butler/concierge service does not include payment mechanisms which are integrated within the messaging applications and portals. In view of this shortcoming, the users typically have to access separate payment facilities (online or otherwise) in order to carry out transactions.

This cumbersome process is undesirable.

### SUMMARY

There is provided a system for making payment within a digital messaging environment, the system including one or more electronic processing devices that: access, at the user device, a digital messaging environment for communication with a merchant device; assess, at the digital messaging environment, messaging content input by the user device and the merchant device; locate, at the digital messaging environment, predetermined text for purchasing at least one good/service; authenticate, at the user device, a user of the user device; transmit, from a digital wallet server to the user device, a positive authentication result for the user; transmit, from the digital wallet server to a payment system, a payment quantum for purchasing the at least one good/service; transmit, from the digital wallet server to the payment system, a payment amounting to the payment quantum; and receive, at the user device from the payment system, an indication that the payment for the at least one good/service has been carried out.

The system can further including one or more electronic processing devices that input, at the user device, a profile ID of a digital wallet.

It is preferable that assessing the messaging content includes parsing the messaging content.

Preferably, the predetermined text is associated with a unique identifier, the unique identifier being configured to activate a payment process when an associated predetermined text is identified.

Authentication is preferably carried out via a digital wallet interface. It is preferable that the payment quantum is less than a predetermined amount. It is also preferable that a record of the payment is stored external to the user device.

There is also provided an apparatus for making payment within a digital messaging environment, the apparatus including one or more electronic processing devices that: access a digital messaging environment for communication with a merchant device; assess, at the digital messaging environment, messaging content input by the user device and the merchant device; locate, at the digital messaging environment, predetermined text for purchasing at least one good/service; authenticate a user of the user device; receive, from a digital wallet server, a positive authentication result for the user; and receive, from a payment system, an indication that the payment for the at least one good/service has been carried out.

The apparatus can further include one or more electronic processing devices that input a profile ID of a digital wallet.

It is preferable that assessing the messaging content includes parsing the messaging content. The predetermined text can be associated with a unique identifier, the unique identifier being configured to activate a payment process when an associated predetermined text is identified.

Authentication can preferably be carried out via a digital wallet interface. The payment quantum can be less than a predetermined amount, and a record of the payment can be stored external to the apparatus.

There is also provided a non-transitory computer readable storage medium embodying thereon a program of computer readable instructions which, when executed by one or more processors of a user device in communication with at least one server, cause the user device to perform a method for making payment within a digital messaging environment, the method embodying the steps of: accessing a digital messaging environment for communication with a merchant device; assessing, at the digital messaging environment, messaging content input by the user device and the merchant device; locating, at the digital messaging environment, predetermined text for purchasing at least one good/service; authenticating a user of the user device; receiving, from a digital wallet server, a positive authentication result for the user; and receiving, from a payment system, an indication that the payment for the at least one good/service has been carried out.

The storage medium can further embody the method step of inputting a profile ID of a digital wallet.

It is preferable that assessing the messaging content includes parsing the messaging content.

Preferably, the predetermined text is associated with a unique identifier, the unique identifier being configured to activate a payment process when an associated predetermined text is identified. The authentication can be carried out via a digital wallet interface. The payment quantum is preferably less than a predetermined amount, and a record of the payment can be stored external to the user device.

In another aspect, there is provided a data processor implemented method for making payment within a digital messaging environment, the method comprising, in one or more electronic processing devices: accessing, at a user device, a digital messaging environment for communication with a merchant device; assessing, at the digital messaging environment, content input via the user device and the merchant device; locating, at the digital messaging environment, predetermined text for purchasing at least one good/service; authenticating, at the user device, a user of the user device; transmitting, from a digital wallet server to the user device, a positive authentication result for the user; transmitting, from the digital wallet server to a payment system, a payment quantum for the at least one good/service; transmitting, from the digital wallet server to the payment system, a payment amounting to the payment quantum; and receiving, at the user device from the payment system, an indication that the payment has been carried out.

The method can further include inputting, at the user device, a profile ID of a digital wallet.

It is preferable that assessing the messaging content includes parsing the messaging content. The predetermined text can preferably be associated with a unique identifier, the unique identifier being configured to activate a payment process when an associated predetermined text is identified.

The authentication can be carried out via a digital wallet interface. The payment quantum can preferably be less than a predetermined amount. It is also preferable that a record of the payment is stored external to the user device.

### DESCRIPTION OF FIGURES

In order that the present invention may be fully understood and readily put into practical effect, there shall now be described by way of non-limitative example only, certain embodiments of the present invention, the description being with reference to the accompanying illustrative figures, in which:

FIG. 1 is a flow chart of an example of a method for making payment within a digital messaging environment;

FIG. 2 is a schematic diagram of an example of a system for making payment within a digital messaging environment;

FIG. 3 is a schematic diagram showing components of an example user device of the system shown in FIG. 2;

FIG. 4 is a schematic diagram showing components of an example communications server of the system shown in FIG. 2; and

FIG. 5 is a schematic diagram showing components of an example payment processing device of the system shown in FIG. 2; and

FIGS. 6A to 6B is a flowchart of a specific example of a method for making payment within a digital messaging environment.

### DETAILED DESCRIPTION

There is provided a method, and system for making payment within a digital messaging environment. In at least some embodiments, the method, and system allow users to make payment for goods/services within a digital messaging environment, where in the past, it would not be possible due to lack of integration of payment services/facilities within a digital messaging environment. The method, and system provide users with an improved user experience when making payments for goods/services within a digital messaging environment.

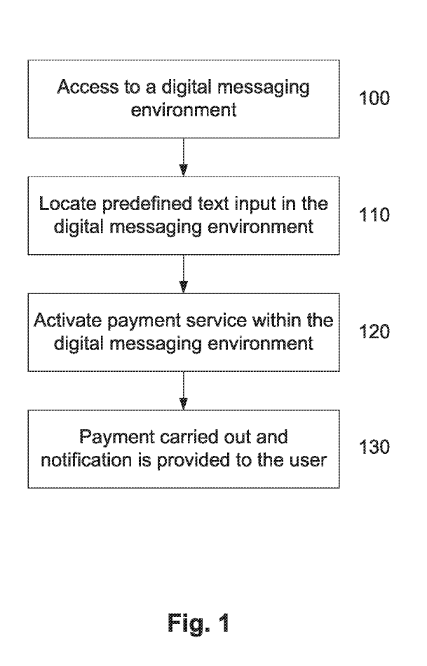

An example of a method for making payment within a digital messaging environment will now be described with reference to FIG. 1.

For the purpose of illustration, it is assumed that the method is performed at least in part using one or more electronic processing devices such as a suitably programmed microcontroller forming part of a user device, such as mobile phones, portable computers, tablet computers, or the like. The user devices are also typically in communication with a payment system which may comprise any suitable computer system such as a server that is capable of processing payments made by the user and which may include a number of processing devices associated with each of an issuer, acquirer, card network and payment gateway, or alternatively, the payment processing system may include any one or more of these entities and this will be discussed further below.

In this example, at step 100 the one or more electronic processing devices provide access to a digital messaging environment in the user device, the digital messaging environment being accessible with an appropriate software application, or via an online portal. The digital messaging environment is typically, but not limited to carrying out conversations and exchanging media between users and merchants (providers of goods and/or services). The digital messaging environment can include artificial intelligence (AI) aspects that are configured to automate simple tasks within the digital messaging environment. The user device is also typically connected to a data network via either a wired or a wireless connection.

At step 110, the one or more electronic processing devices then receive instructions to locate predefined text input in the digital messaging environment. Location of the predefined text enables initiation of a payment transaction within the digital messaging environment.

At step 120, the one or more electronic processing devices then activate a payment service within the digital messaging environment. The user is then authenticated via a digital wallet application, whereby biometric information, PIN, password, and so forth is input via the digital wallet application. Once the user is authenticated, the transaction may then be processed in a similar way to which a standard e-commerce transaction is performed with a merchant.

At step 130, the one or more electronic processing devices then facilitates the carrying out of payment to the merchant and notification is then provided to the user within the digital messaging environment.

The above described method provides a number of advantages. Firstly, the method enables payment for goods and/or services to be carried out within a digital messaging environment in a manner which is activated automatically, and without a need to access separate payment portals. This is advantageous as accessing separate payment portals typically require more data processing capabilities and more RAM before the payments can be carried out. Furthermore, the user is also able to avoid additional steps and save time when making payment for goods and/or services within a digital messaging environment. This overcomes existing drawbacks of current digital messaging environments where making payment for goods and/or services within a digital messaging environment is not available.

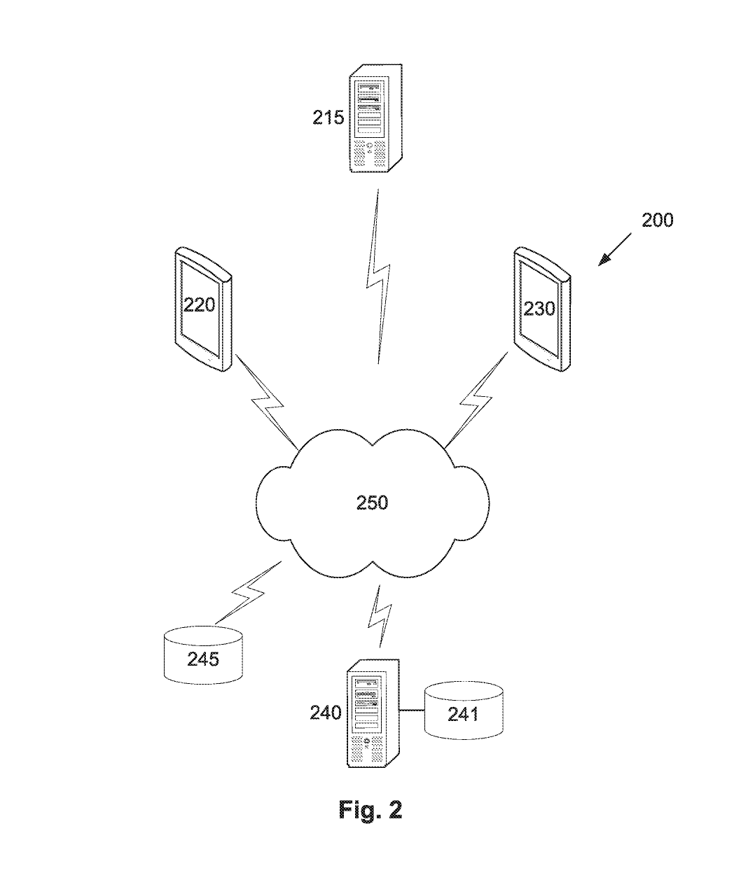

An example of a system 200 for making payment within a digital messaging environment will now be described with reference to FIG. 2.

In this example, the system 200 includes a communications server 215 in communication with one or more user devices 220 optionally running a payment (for example, digital wallet) application and one or more merchant devices 230 optionally running a merchant application. A digital wallet server 245 can host the payment application running on the one or more user devices 220. The communications server 215 can be configured to host a digital messaging environment. The user and merchant devices 220, 230 are in communication with a payment system 240 via a communications network 250. The payment system 240 may be in communication with a database 241.

The communications network 250 can be of any appropriate form, such as the Internet and/or a number of local area networks (LANs). It will be appreciated that the configuration shown in FIG. 2 is for the purpose of example only, and in practice the user devices 220, merchant devices 230, communications server 215, digital wallet server 245 and payment system 240 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like. Typically, the one or more user and merchant devices 220, 230 communicate with the communications server 215 via a wireless communication protocol such as a mobile network, Bluetooth, Wi-Fi, Zigbee, or through Near Field Communication (NFC) but not limited to such. The user and merchant devices 220, 230 may typically communicate with the payment system over a mobile network or via the Internet.

### User Device 220 and Merchant Device 230

The user device 220 and merchant device 230 of any of the examples herein may be a handheld computer device such as a smart phone or a PDA such as one manufactured by Apple™, LG™, HTC™, Research In Motion™, or Motorola™.

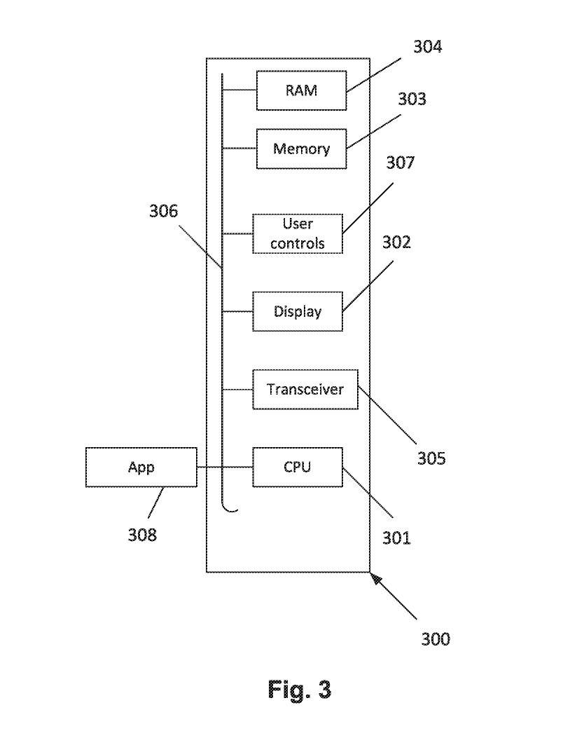

The user device 220 or merchant device 230 may include a mobile computer such as a tablet computer. An exemplary embodiment of a user device 300 is shown in FIG. 3. As shown, the device 300 includes the following components in electronic communication via a bus 306:

1. a display 302;
2. non-volatile memory 303;
3. random access memory (“RAM”) 304;
4. N processing components 301;
5. a transceiver component 305 that includes N transceivers; and
6. user controls 307.

Although the components depicted in FIG. 3 represent physical components, FIG. 3 is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

The display 302 generally operates to provide a presentation of content to a user, and may be realized by any of a variety of displays (e.g., CRT, LCD, HDMI, microprojector and OLED displays). And in general, the non-volatile memory 303 functions to store (e.g., persistently store) data and executable code including code that is associated with the functional components of a browser component and applications, and in one example, a payment application 308 executing on the user device 220 and a merchant application executing on the merchant device 230. In some embodiments, for example, the non-volatile memory 303 includes bootloader code, modem software, operating system code, file system code, and code to facilitate the implementation of one or more portions of the payment application 308 as well as other components well known to those of ordinary skill in the art that are not depicted for simplicity.

In many implementations, the non-volatile memory 303 is realized by flash memory (e.g., NAND or ONENAND memory), but it is certainly contemplated that other memory types may be utilized as well. Although it may be possible to execute the code from the non-volatile memory 303, the executable code in the non-volatile memory 303 is typically loaded into RAM 304 and executed by one or more of the N processing components 301.

The N processing components 301 in connection with RAM 304 generally operate to execute the instructions stored in non-volatile memory 303 to effectuate the functional components. As one of ordinarily skill in the art will appreciate, the N processing components 301 may include a video processor, modem processor, DSP, graphics processing unit (GPU), and other processing components.

The transceiver component 305 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

### Communications Server 215

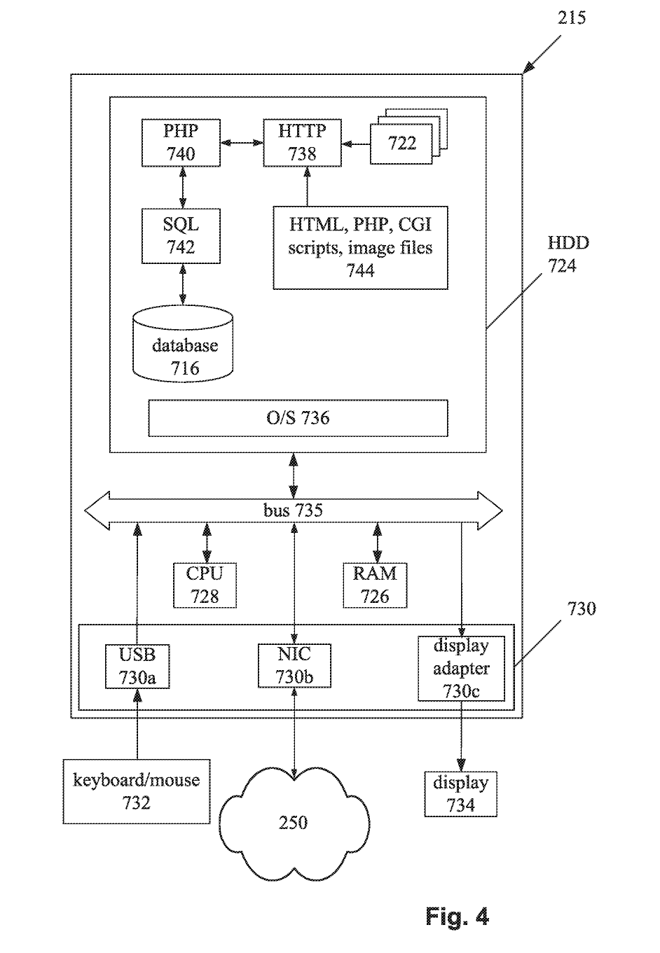

An example of the communications server 215 is as shown in FIG. 4. The communications server 215 is able to communicate with the user device 220 and the merchant device 230 over a communications network 250 using standard communication protocols.

The components of the communications server 215 can be configured in a variety of ways. The components can be implemented entirely by software to be executed on standard computer server hardware, which may comprise one hardware unit or different computer hardware units distributed over various locations, some of which may require the communications network 250 for communication. A number of the components or parts thereof may also be implemented by application specific integrated circuits (ASICs) or field programmable gate arrays.

In the example shown in FIG. 4, the communications server 215 is a commercially available server computer system based on a 32 bit or a 64 bit Intel architecture, and the processes and/or methods executed or performed by the communications server 215 are implemented in the form of programming instructions of one or more software components or modules 722 stored on non-volatile (e.g., hard disk) computer-readable storage 724 associated with the communications server 215. At least parts of the software modules 722 could alternatively be implemented as one or more dedicated hardware components, such as application-specific integrated circuits (ASICs) and/or field programmable gate arrays (FPGAs).

The communications server 215 includes at least one or more of the following standard, commercially available, computer components, all interconnected by a bus 735:

1. random access memory (RAM) 726;
2. at least one computer processor 728, and
3. external computer interfaces 730:
a. universal serial bus (USB) interfaces 730a (at least one of which is connected to one or more user-interface devices, such as a keyboard, a pointing device (e.g., a mouse 732 or touchpad),
b. a network interface connector (NIC) 730b which connects the computer system 700 to a data communications network, such as the Internet 250; and
c. a display adapter 730c, which is connected to a display device 734 such as a liquid-crystal display (LCD) panel device.

The communications server 215 includes a plurality of standard software modules, including:

1. an operating system (OS) 736 (e.g., Linux or Microsoft Windows);
2. web server software 738 (e.g., Apache, available at http://www.apache.org);
3. scripting language modules 740 (e.g., personal home page or PHP, available at http://www.php.net, or Microsoft ASP); and
4. structured query language (SQL) modules 742 (e.g., MySQL, available from http://www.mysql.com), which allow data to be stored in and retrieved/accessed from an SQL database 716.

Together, the web server 738, scripting language 740, and SQL modules 742 provide the communications server 215 with the general ability to allow users of the Internet 250 with user device 220 and merchant device 230 equipped with standard web browser software to access the communications server 215 and in particular to provide data to and receive data from the database 716. It will be understood by those skilled in the art that the specific functionality provided by the communications server 215 to such users is provided by scripts accessible by the web server 738, including the one or more software modules 722 implementing the processes performed by the computer system 700, and also any other scripts and supporting data 744, including markup language (e.g., HTML, XML) scripts, PHP (or ASP), and/or CGI scripts, image files, style sheets, and the like.

The boundaries between the modules and components in the software modules 722 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the communications server 215 may be executed by a module (of software modules 722) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The communications server 215 normally processes information according to a program (a list of internally stored instructions such as a particular application program and/or an operating system) and produces resultant output information via input/output (I/O) devices 730. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

### Digital Wallet Server 245

An example of the digital wallet server 245 is as shown in FIG. 2. The digital wallet server 245 is able to communicate with the user device 220 and the merchant device 230 over a communications network 250 using standard communication protocols. The digital wallet server 245 typically stores a plurality of profile IDs for respective users of digital wallets.

When a digital wallet on the user device 220 is invoked, a wallet application on the user device 220 generates payment data which is transmitted to the merchant device 230. The payment data comprises the amount of the payment, a tokenized version of the PAN of the selected payment instrument, the expiry date of the payment instrument, and other information required to generate an authorization request for a transaction (for example, formatted according to the ISO8583 standard) as will be understood by those skilled in the art. The merchant device 230 then submits an authorization request to, for example, a payment service provider (PSP) or the merchant's acquirer in known fashion.

Many methods of conducting secure electronic commerce transactions are known in the art. For example, U.S. Pat. No. 7,058,611 describes in some detail a method involving the SET™ protocol which facilitates secure payment card transactions over the Internet. The disclosure of U.S. Pat. No. 7,058,611 in its entirety is hereby incorporated into this specification for all purposes by way of reference.

Further, U.S. patent application Ser. No. 13/209,312 generally discloses a phone-based electronic wallet that provides transactions across multiple channels of commerce. The electronic wallet described therein can be used for point of sale payments, remote mobile payments and/or web based payments. The disclosure of U.S. patent application Ser. No. 13/209,312 in its entirety is hereby incorporated into this specification for all purposes by way of reference.

Further still, U.S. patent application Ser. No. 13/835,088 generally discloses a system of tokenizing sensitive cardholder payment information for use in cashless transactions. The disclosure of U.S. patent application Ser. No. 13/835,088 in its entirety is hereby incorporated into this specification for all purposes by way of reference. Tokenization is also described in detail in the document “EMV Payment Tokenisation Specification—Technical Framework” (version 1.0, March 2014) of EMV Co., which is hereby incorporated into this specification for all purposes by reference. The EMV Payment Tokenisation Specification is available at www.emvco.com.

U.S. patent application Ser. No. 13/746,904 entitled “System and method to enable a network of digital wallets”, includes a federated network of electronic wallets. The disclosure of U.S. patent application Ser. No. 13/746,904 in its entirety is hereby incorporated into this specification for all purposes by way of reference.

### Verified by Visa Acquirer and Merchant Implementation Guide

(http://usa.visa.com/download/merchants/verified-by-visa-acquirer-merchant-implementation-guide.pdf) describes a 3D secure online program designed to make Internet purchase transactions safer by authenticating a cardholder's identity at the time of purchase, before the merchant submits an authorization request. This document, in its entirety, is hereby incorporated into this specification for all purposes by way of reference.

### MasterCard Secure Code

(https://www.mastercard.us/content/dam/mccom/en-us/documents/SMI Manual.pdf) describes another 3D secure online program. This document, in its entirety, is hereby incorporated into this specification for all purposes by way of reference.

It is anticipated that the user device 220 can effect payment by way of any suitable electronic/online wallet system, including any one of the above systems.

### Payment System 240

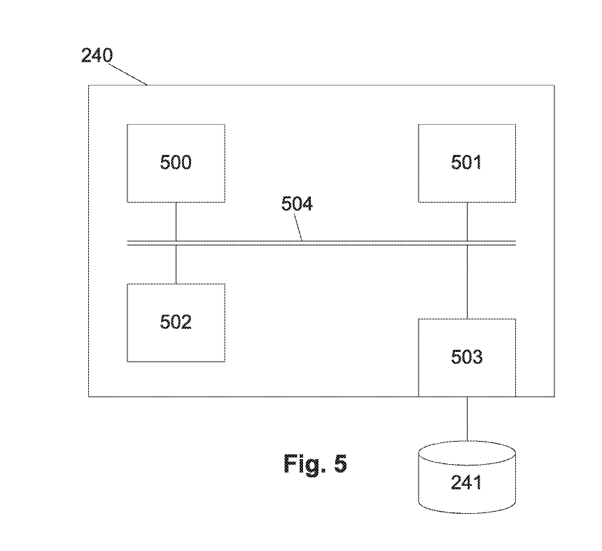

A suitable payment system 240 for use in the system described in anyone of the above examples is shown in FIG. 5.

In this example, the payment system 240 is a server that includes at least one microprocessor 500, a memory 501, an optional input/output device 502, such as a display, keyboard, touchscreen and the like, and an external interface 503, interconnected via a bus 504 as shown. In this example the external interface 503 can be utilised for connecting the payment server 240 to peripheral devices, such as the user and merchant devices 220, 230, the communication networks 250, databases 241, other storage devices, or the like. Although a single external interface 503 is shown, this is for the purpose of example only, and in practice multiple interfaces using various methods (e.g. Ethernet, serial, USB, wireless or the like) may be provided.

In use, the microprocessor 500 executes instructions in the form of applications software stored in the memory 501 to allow communication with the user device 220, for example to deduct payment from a profile ID of a digital wallet, and the merchant device 230, for example to indicate that payment for goods/services has been made. The applications software may include one or more software modules, and may be executed in a suitable execution environment, such as an operating system environment, or the like.

Accordingly, it will be appreciated that the payment system 240 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. However, the payment system 240 may also be formed from a suitably programmed PC, Internet terminal, lap-top, or hand-held PC, a tablet, or smart phone, or the like. Thus, in one example, the payment system 240 is a standard processing system such as an Intel Architecture based processing system, which executes software applications stored on non-volatile (e.g., hard disk) storage, although this is not essential.

In other examples, such as described above, the payment system is formed of multiple computer systems interacting, for example, via a distributed network arrangement. As distributed networking is known in the art, it will not be described further in more detail.

In particular, the payment system may include or be in communication with a number of processing systems associated with each of an issuer, acquirer, card network and payment gateway, or alternatively, the payment system may be any one or more of these entities.

In one example as will be well understood in the art, the payment system sends the user account information and payment information to the merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

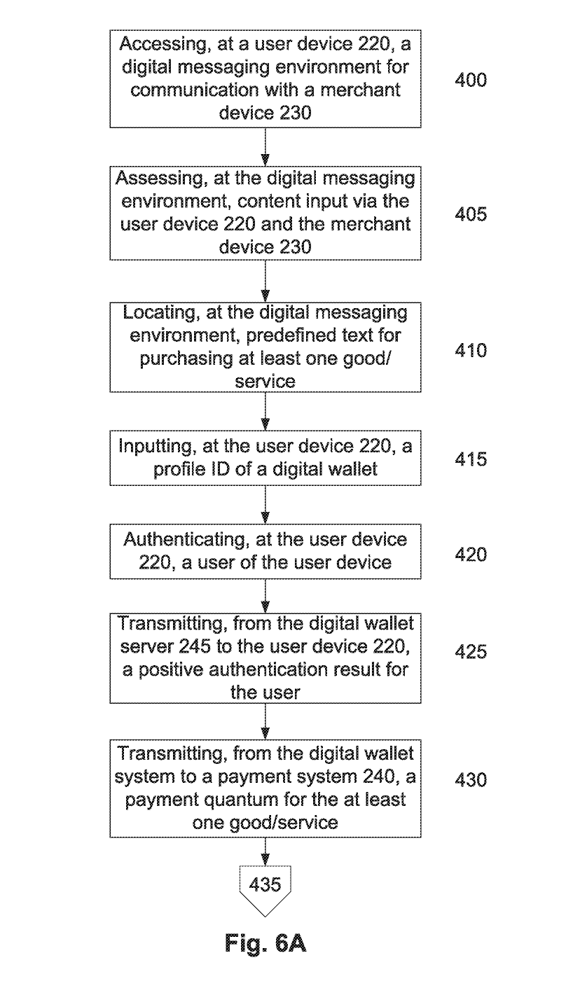

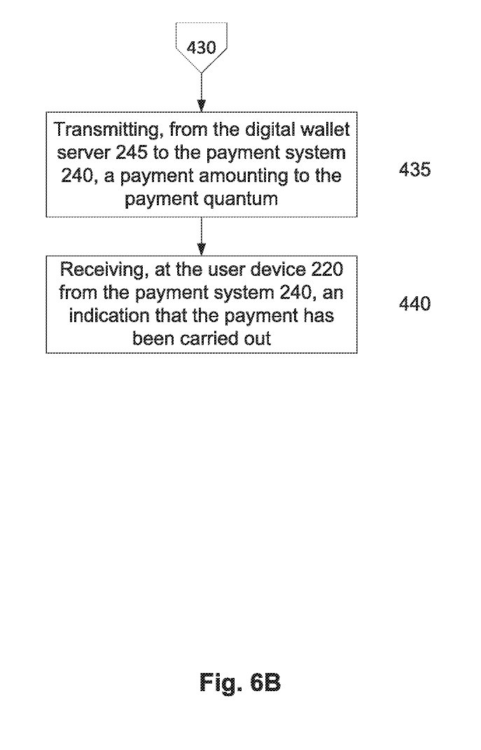

To illustrate further features of preferred practical implementations of the method, a further detailed example of a method for making payment within a digital messaging environment will now be described with reference to FIGS. 6A-6B. The method will be described with reference to the system 200 of FIG. 2, although the method can be carried out using other system setups, and using one or more electronic processing devices.

At step 400, a user accesses, at a user device 220, a digital messaging environment for communication with a merchant device 230. The digital messaging environment is hosted by the communications server 215. The digital messaging environment is typically, but not limited to carrying out conversations and exchanging media between users and merchants (providers of goods and/or services). The digital messaging environment can include artificial intelligence (AI) aspects that are configured to automate simple tasks within the digital messaging environment.

At step 405, content input via the user device 220 and the merchant device 230 is continually assessed at the digital messaging environment. Assessment of the messaging content typically includes parsing the messaging content. For example, text input by the user and the merchant is continually assessed to determine if specific actions should be carried out at the digital messaging environment. This is in accordance with the artificial intelligence (AI) aspects that are configured to automate simple tasks within the digital messaging environment.

At step 410, predetermined text for purchasing at least one good/service is located at the digital messaging environment. The predetermined text is associated with a unique identifier, the unique identifier being configured to activate a payment process when an associated predetermined text is identified. For example, the predetermined text can include, pay, buy, confirm order, proceed, equivalents of the aforementioned in other languages and so forth.

At step 415, after the payment process is activated, the user inputs his/her profile ID of a digital wallet at the user device 220. It should be appreciated that the step 415 need not be a mandatory step, and is only carried out, for example, at a first instance when the payment process is activated in the digital messaging environment, whenever a payment quantum exceeds a maximum defined amount, whenever an unusual purchase compared to earlier purchases made with the digital wallet, and so forth. Step 415 need not be a mandatory step if there is an assumption that the user of the user device 220 does not vary. It should be appreciated that a record of earlier purchases made with the digital wallet is not stored locally on the user device 220, and can be stored at the digital wallet server 245.

At step 420, a user of the user device 220 is authenticated at the user device 220. The authentication of the user can be carried out via a digital wallet interface provided by a digital wallet application running on the user device 220. The authentication can be carried out at the digital wallet application using, for example, biometric information, a PIN, a password, and so forth. Whilst step 420 can be optional, it should be noted that a security of the user's digital wallet is enhanced if step 420 is mandatory.

At step 425, a positive authentication result for the user is transmitted from the digital wallet server 245 to the user device 220. Subsequently, as step 430, a payment quantum for the at least one good/service is transmitted from the digital wallet server 245 to a payment system 240. It should be noted that the payment quantum can be less than a predetermined amount, in a manner where there is a capped amount on the payment that can be made. Any payment above the predetermined amount may require an additional authorisation or authentication process.

At step 435, a payment amounting to the payment quantum is transmitted from the digital wallet server 245 to the payment server 240. It should be appreciated that payment is transmitted in a manner as described in the preceding sections. Finally, at step 440, an indication that the payment has been carried out is received at the user device 220 from the payment server 240. The user is consequently informed that the requisite payment has been carried out by the digital wallet while the user is still in the digital messaging environment.

Accordingly, it will be appreciated that in at least one example the above described methods and system may enable payment for goods and/or services within a digital messaging environment, in a manner which is activated automatically, and without a need to access separate payment portals. This is advantageous as accessing separate payment portals typically require more data processing capabilities and more RAM before the payments can be carried out. Furthermore, the user is also able to avoid additional steps and save time when making payment for goods and/or services within a digital messaging environment. This overcomes existing drawbacks of current digital messaging environments where making payment for goods and/or services within a digital messaging environment is not available.

Whilst there have been described in the foregoing description preferred embodiments of the present invention, it will be understood by those skilled in the technology concerned that many variations or modifications in details of design or construction may be made without departing from the present invention.

1. A system for making payment within a digital messaging environment, the system including one or more electronic processing devices that:
access, at the user device, a digital messaging environment for communication with a merchant device;
assess, at the digital messaging environment, messaging content input by the user device and the merchant device;
locate, at the digital messaging environment, predetermined text for purchasing at least one good/service;
authenticate, at the user device, a user of the user device;
transmit, from a digital wallet server to the user device, a positive authentication result for the user;
transmit, from the digital wallet server to a payment system, a payment quantum for purchasing the at least one good/service;
transmit, from the digital wallet server to the payment system, a payment amounting to the payment quantum; and
receive, at the user device from the payment system, an indication that the payment for the at least one good/service has been carried out.

2. The system of claim 1, further including one or more electronic processing devices that input, at the user device, a profile ID of a digital wallet.

3. The system of claim 1, wherein assessing the messaging content includes parsing the messaging content, wherein the predetermined text is associated with a unique identifier, the unique identifier being configured to activate a payment process when an associated predetermined text is identified, wherein the authentication is carried out via a digital wallet interface, wherein the payment quantum is less than a predetermined amount, and wherein a record of the payment is stored external to the user device.

4. An apparatus for making payment within a digital messaging environment, the apparatus including one or more electronic processing devices that:
access a digital messaging environment for communication with a merchant device;
assess, at the digital messaging environment, messaging content input by the user device and the merchant device;
locate, at the digital messaging environment, predetermined text for purchasing at least one good/service;
authenticate a user of the user device;
receive, from a digital wallet server, a positive authentication result for the user; and
receive, from a payment system, an indication that the payment for the at least one good/service has been carried out.

5. The apparatus of claim 4, further including one or more electronic processing devices that input a profile ID of a digital wallet.

6. The apparatus of claim 4, wherein assessing the messaging content includes parsing the messaging content, wherein the predetermined text is associated with a unique identifier, the unique identifier being configured to activate a payment process when an associated predetermined text is identified, wherein the authentication is carried out via a digital wallet interface, wherein the payment quantum is less than a predetermined amount and wherein a record of the payment is stored external to the apparatus.

7. A non-transitory computer readable storage medium embodying thereon a program of computer readable instructions which, when executed by one or more processors of a user device in communication with at least one server, cause the user device to perform a method for making payment within a digital messaging environment, the method embodying the steps of:
accessing a digital messaging environment for communication with a merchant device;
assessing, at the digital messaging environment, messaging content input by the user device and the merchant device;
locating, at the digital messaging environment, predetermined text for purchasing at least one good/service;
authenticating a user of the user device;
receiving, from a digital wallet server, a positive authentication result for the user; and
receiving, from a payment system, an indication that the payment for the at least one good/service has been carried out.

8. The storage medium of claim 7, further embodying the method step of inputting a profile ID of a digital wallet.

9. The storage medium of claim 7, wherein assessing the messaging content includes parsing the messaging content, wherein the predetermined text is associated with a unique identifier, the unique identifier being configured to activate a payment process when an associated predetermined text is identified, wherein the authentication is carried out via a digital wallet interface, wherein the payment quantum is less than a predetermined amount, and wherein a record of the payment is stored external to the user device.

10. A data processor implemented method for making payment within a digital messaging environment, the method comprising, in one or more electronic processing devices:
accessing, at a user device, a digital messaging environment for communication with a merchant device;
assessing, at the digital messaging environment, content input via the user device and the merchant device;
locating, at the digital messaging environment, predetermined text for purchasing at least one good/service;
authenticating, at the user device, a user of the user device;
transmitting, from a digital wallet server to the user device, a positive authentication result for the user;
transmitting, from the digital wallet server to a payment system, a payment quantum for the at least one good/service;
transmitting, from the digital wallet server to the payment system, a payment amounting to the payment quantum; and
receiving, at the user device from the payment system, an indication that the payment has been carried out.

11. The method of claim 10, further including inputting, at the user device, a profile ID of a digital wallet.

12. The method of claim 10, wherein assessing the messaging content includes parsing the messaging content, wherein the predetermined text is associated with a unique identifier, the unique identifier being configured to activate a payment process when an associated predetermined text is identified, wherein the authentication is carried out via a digital wallet interface, wherein the payment quantum is less than a predetermined amount, and wherein a record of the payment is stored external to the user device.
